(19) United States
(12) Patent Application Publication
(10) Pub. No.: US 2010/0169220 A1
(43) Pub. Date: Jul. 1, 2010

(54) WEARING HEALTH ON YOUR SLEEVE

(75) Inventors: Hong Choing, Collegeville, PA (US); Kenneth D. Ray, Seattle, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/346,945

(22) Filed: Dec. 31, 2008

(51) Int. Cl. G06Q 50/00; H04L 9/00

(52) U.S. Cl. 705/51; 705/3

(57) ABSTRACT

The claimed subject matter provides systems and/or methods that effectuate accurate communication of health data. The system can include mechanisms that initiate data interchange with a records manager that controls personal health records, and that selectively causes a physicians portal to acquire and display the personal but circumscribed health records associated with the user of the system.

### BACKGROUND

Technological advances in computer hardware, software, and networking have lead to increased demand for electronic information interchange rather than conventional techniques such as paper and telephone communications, for instance. Such electronic communication can provide instantaneous, reliable data transfer between any two disparately situated locations throughout the world. Many industries and consumers are beneficially leveraging such technology to improve efficiency and productivity, and decrease costs through on-line (e.g., web-based) services. For example, consumers can purchase goods, services, review bank statements, research products and companies, obtain real-time stock quotations, and the like, with a click of a mouse and from the convenience of their homes.

As the amount of available electronic data grows it has become more important to store and/or employ data in a manner that facilitates user-friendly and quick access, search and retrieval of such data. In particular, the Healthcare industry has aggressively migrated towards electronic storage solutions for medical records and electronic interchange in terms of health-related data, patient and doctor profiles, hospital reviews, etc. For instance, numerous websites and medical forums provide a welter of information in connection with general medical information (e.g., definitions, overviews, terminology, treatments, prognoses, side-effects, etc.), diagnoses (e.g., presenting symptoms, treatments, prescriptions, . . . ), and medical physicians or facilities (e.g., hospital reviews, physician biographies, and the like).

Nevertheless, despite these countless technological advances, there still remain problems with obtaining pertinent healthcare information via the web as there is an overwhelming abundance of available information. Further, the format and file types associated with medical data is as varied as the quantity and quality of medical data available on the web; compatibility and utility for such data becomes suspect in light of disparate file types, formats, quality, and the like. Moreover, much of the useful medical data currently available can be application, software, and/or hardware specific.

Human-machine interface systems can come in many disparate forms. There is the common graphical user interface typically utilized on desktop and laptop computers, and various other forms such as button controls and menus commonly employed by mobile devices such as cell phones. Most interface systems operate in generally static environments and typically provide static predetermined choices as to how human can interact with the respective systems. For instance, when opening a cell phone, a predetermined prescribed menu listing is provided to the user that allows for customization of the various features of the phone, such as sounds, themes, numbers, functionality, and the like. In desktop applications, depending on the application selected, a generally standard set of interfaces and static grouping of interface options can be provided. These interfaces however cannot account for the particular nuances of an individual on any given day. For example, if an individual were to be transported to a hospital emergency room in an incoherent state, current interface technologies are unable to convey to hospital emergency room staff any pertinent health information (e.g., medical history, prescription drug usage, drug intolerances, insurance details, name, age, blood group, current heart rate, current blood pressure, and the like) related specifically to the presenting individual. Moreover, in a litigious society medical malpractice suits due to the inability of physicians to see the full extent of a presenting patient's medical and drug histories, drug interaction issues, and/or food intake prior to presentation can unfortunately become reality extremely quickly.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

In the field of medicine, health conditions and health-related data are not always accurately communicated. For example, doctors cannot always trust patients when diagnosing a condition. The claimed subject matter in accordance with an aspect improves methods for collecting and portraying health conditions. Further, the subject matter as claimed in accordance with a further aspect provides a system associated with an individual that monitors and records information (e.g., a number of visits to the gym, workout activities, frequency of workouts, heart rate readings, blood pressure statistics, food consumption, vitamin intake, etc.) about the individual associated with the system. The disclosed and claimed system can then consolidate the data and convert the data into a visual form so that others (e.g., doctors, potential dates, etc.) can see the data, on mechanisms such as a mood ring, watch, badge, on a website etc.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that facilitates and effectuates accurate communication of health data in accordance with the claimed subject matter.

FIG. 2 depicts a further machine-implemented system that facilitates and effectuates accurate communication of health data in accordance with an aspect of the claimed subject matter.

FIG. 3 provides a more detailed depiction of an illustrative communicator device that facilitates and effectuates accurate communication of health data in accordance with an aspect of the claimed subject matter.

FIG. 4 provides a more detailed depiction of a consolidated health repository that facilitates and effectuates accurate communication of health data in accordance with an aspect of the claimed subject mater.

FIG. 5 provides a more detailed depiction of a physicians portal that facilitates and effectuates accurate communication of health data in accordance with an aspect of the claimed subject mater.

FIG. 6 depicts yet another illustrative aspect of a system that facilitates and effectuates accurate communication of health data in accordance with an aspect of the claimed subject mater.

FIG. 7 illustrates a flow diagram of a machine implemented methodology that facilitates and effectuates accurate communication of health data in accordance with an aspect of the claimed subject mater.

FIG. 8 illustrates a block diagram of a computer operable to execute the disclosed system in accordance with an aspect of the claimed subject matter.

FIG. 9 illustrates a schematic block diagram of an exemplary computing environment for processing the disclosed architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

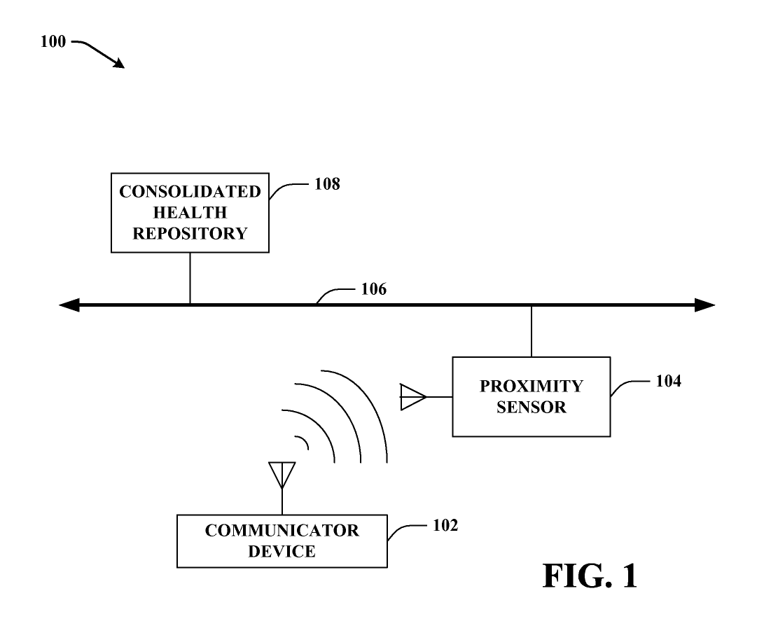

FIG. 1 illustrates a machine implement system 100 that facilitates and effectuates accurate communication of health data between a communicator device 102 and a consolidated health repository 108. System 100 in addition to communicator device 102 and consolidated health repository 108 can also include proximity sensor 104 that detects the presence of communicator device 102 and relays indication of the proximity of communicator device 102 to consolidated health repository 108 via network topology and/or cloud 106. As depicted, communicator device 102 can be a wearable or portable device that can be detectable by proximity sensor 104 or that can itself detect the existence of proximity sensor 104. For example, communicator device 102 can periodically and/or continuously emit a signal detectable by proximity detector 104. Alternatively and/or additionally, proximity detector 104 can periodically and/or continuously transmit its presence so that communicator device 102 can become aware that it is in the vicinity of proximity sensor 104. Upon detection, either by communicator device 102 locating proximity sensor 104 or proximity device 104 identifying communicator device 102, communicator device 102 can initiate communications with consolidated health repository 108 wherein health related and personal data associated with a wearer or carrier of communicator device 102 can be transmitted, communicated, or interchanged between consolidated health repository 108 and communicator device 102 via network topology and/or cloud 106. In this manner wearers or carriers of communicator device 102 can have easy access to their personal health records at anytime and anywhere so that, for instance, if they need access to emergency treatment the whole gamut of their past medical records can be presented to a healthcare practitioner without the wearer or carrier of the device needing to be in a coherent state to relay such pertinent information to the medical practitioner.

As illustrated, communicator device 102 can be in continuous and/or operative, or intermittent but sporadic communication with consolidated health repository 108 via proximity sensor 104 and network topology and/or cloud 106. Communicator device 102 can be implemented entirely in hardware and/or a combination of hardware and/or software in execution. Further, communicator device 102 can be incorporated within and/or associated with other compatible components. Moreover, communicator device 102 can be any type of machine that includes a processor and/or is capable of effective communication with proximity sensor 104 and network topology and/or cloud 106. Illustrative machines that can comprise communicator device 102 can include cell phones, smart phones, laptop computers, notebook computers, Tablet PCs, consumer and/or industrial devices and/or appliances, hand-held devices, personal digital assistants, server class machines and/or computing devices and/or databases, Global Positioning Systems (GPS), multimedia Internet enabled mobile phones, multimedia players, automotive components, avionics components, and the like. Additionally, communicator device 102 can be included with, or incorporated in, textiles, fabrics, clothing, jewelry, or any item that can be worn. Additionally, communicator device 102 can be Radio Frequency Identification (RFID) devices, or can incorporate or subsume Radio Frequency Identification (RFID) devices. For example, communicator device 102 can be a wrist band that has embedded therein a Radio Frequency Identification (RFID) tag or chip that can continuously obtain information (e.g., blood pressure, body temperature, perspiration, pupil dilation, heart rate, location information from global positioning systems, . . . ) from the wearer of the wrist band.

Proximity sensor 104, as illustrated, can be in constant or intermittent communication with communicator device 102 and, via network topology and/or cloud 106, in continuous and/or sporadic communication with consolidated health repository 108. Proximity sensor 104 can be deployed within a communications infrastructure such as wireless cell phone towers, satellite base stations, and the like. Proximity sensor 104 can also be any mechanism or device that can be utilized to measure or observe activity or inactivity associated with a particular individual. Proximity sensor 104 can include, without limitation, microphones, cameras, accelerometers, heat sensors, thermometers, devices associated with exercise machines such as elliptical machines, treadmills, exercise bicycles, step machines, devices incorporated into running tracks, swimming pools, basketball courts, and the like, devices utilized in home and/or office environments to monitor ambient variables (e.g., thermostats, motion detectors, and the like), or any other device or component that can be utilized to detect the presence of communicator device 102. Additionally, proximity sensor 104 can be implemented entirely in hardware and/or as a combination of hardware and/or software in execution. Further, proximity sensor 104 can be any type of mechanism, machine, device, facility, and/or instrument that includes a processor and is capable of effective and/or operative communication with network topology and/or cloud 106 and communicator device 102. Illustrative mechanisms, machines, devices, facilities, and/or instruments that can comprise proximity sensor 104 can include Tablet PCs, server class computing machines, laptop computers, notebook computers, desktop computers, cell phones, smart phones, consumer appliances and/or instrumentation, industrial devices and/or components, hand-held devices, personal digital assistants, multimedia Internet enabled phones, Global Positioning Systems (GPS), multimedia players, and the like.

Network topology and/or cloud 106 can include any viable communication and/or broadcast technology, for example, wired and/or wireless modalities and/or technologies can be utilized to effectuate the claimed subject matter. Moreover, network topology and/or cloud 106 can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof. Additionally, network topology and/or cloud 106 can include or encompass communications or interchange utilizing Near-Field Communications (NFC) and/or communications utilizing electrical conductance of the human skin, for example.

Consolidated health repository 108 can be an online repository and/or directed search facility that persists or stores an individual's health data ranging from test results to physician's reports to daily measurements of weight or blood pressure. Individuals can then have access to their records at any time, anywhere, via network topology and/or cloud 106 and utilization of communicator device 102. Affiliated medical practitioners, medical offices, and/or hospitals can, for instance, easily forward test results in digital form to consolidated health repository 108, and individuals (e.g. patients) can in turn authorize selected medical practitioners, medical offices, hospitals, components owned or controlled by the individual, and the like, to access various carefully circumscribed aspects of their personal data. Additionally and/or alternatively, consolidated health repository 108 can also provide directed and/or targeted vertical search capabilities that can provide more relevant results than generalist search engines. For instance, a search actuated on consolidated health repository 108 can allow individuals to specifically tailor their search queries based on their persisted health records, past queries, and the like, and can receive in return results that are most relevant to each individual's situation. Consolidated health repository 108, like communicator device 102 and proximity device 104, can be implemented entirely in hardware and/or as a combination of hardware and/or software in execution. Further, consolidated health repository 108 can be any type of engine, machine, instrument of conversion, or mode of production that includes a processor and/or is capable of effective and/or operative communications with network topology and/or cloud 106, proximity sensor 104 and/or communicator device 102. Illustrative instruments of conversion, modes of production, engines, mechanisms, devices, and/or machinery that can comprise and/or embody consolidated health repository 108 can include desktop computers, server class computing devices and/or databases, cell phones, smart phones, laptop computers, notebook computers, Tablet PCs, consumer and/or industrial devices and/or appliances and/or processes, hand-held devices, personal digital assistants, multimedia Internet enabled mobile phones, multimedia players, and the like.

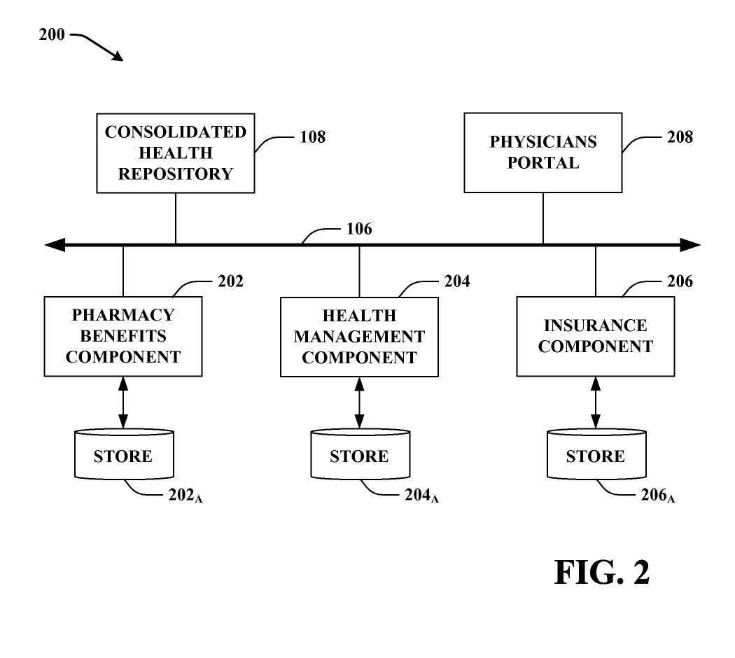

FIG. 2 provides further illustration of a system 200 that facilitates and effectuates accurate communication of health data in accordance with a further aspect of the claimed subject matter. As illustrated, system 200 can include network topology and/or cloud 106 and consolidated health repository 108, detailed descriptions of which have been omitted to avoid needless repetition and for the sake of brevity and conciseness of exposition. System 200 can also include pharmacy benefits component 202 with associated storage or persistence media 202_{A}, health management component 204 and affiliated persistence media 204_{A}, insurance component 206 and confederated storage devices 206_{A}, and physicians portal 208. Each of pharmacy benefits component 202, health management component 204, insurance component 206, and physicians portal 208 can be in continuous or sporadic communication with one another or with consolidated health repository 108 via network topology and/or cloud 106.

As illustrated system 200 can include pharmacy benefits component 202 that can store data related to drugs, drug programs, drugs that an individual utilizing, carrying, or wearing communicator device 102 has taken and/or is currently taking. As will be appreciated by those conversant in this field of endeavor, many instances of medical malpractice can stem from inadvertent but fatal drug interactions. Further, pharmacy benefits component 202 can typically be affiliated or associated with organizations that provide third party administration of prescription drug programs. Thus, utilization of pharmacy benefits component 202 in conjunction, or cooperation, with other illustrative aspects of the claimed subject matter can avoid such potentially catastrophic and distressing situations from occurring.

Further, system 200 can also include health management component 204 that can track and/or persist information regarding an individual using, carrying, and/or wearing communicator device 102. Information that can tracked and/or persisted can include past and/or present illnesses, syndromes, familial histories or dispositions to particular diseases (e.g., breast cancer), ethnological vulnerabilities to particular ailments (e.g., skin cancer, heart disease, and the like), etc. Additionally and/or alternatively, health management component 204 can maintain records regarding when and where the individual employing communicator device 102 traveled. For example, in this modern age, it is not unusual for people to travel to exotic locations for business or vacation and as a consequence to unwittingly acquire many infectious agents (e.g., malaria, typhoid, tuberculosis, small pox, cholera, etc.) and/or viruses (e.g., hepatitis, Ebola virus, and the like) that can lead to sicknesses.

Insurance component 206 can also be beneficially utilized by system 200. For instance insurance component 206 can be a database (or series of databases) associated with one or more insurance companies wherein insurance data associated with the individual employing, wearing, or carrying communicator device 102 can be stored and utilized by system 200. Moreover, since insurance companies typically maintain and employ actuarial tables on arcane outcomes, system 200, or more particularly the claimed subject matter in its entirety can beneficially employ these tables to effectuate its objectives.

Physicians portal 208 can be employed by physicians or in healthcare situations (e.g., hospitals, emergency rooms, sites of accidents, doctors offices, and the like) to bring forth data associated with an individual utilizing, wearing, or carrying communicator device 102. Physicians portal 208 can engage in data interchange with consolidated health repository 108 and communicator device 102 via network topology and/or cloud 106. For instance, in accordance with an aspect of the claimed subject matter, communicator device 102 can provide security information (e.g., biometric information, Personal Identification Numbers (PINs), cryptographic keys, and the like) necessary to obtain health records from consolidated health repository 108. In turn, consolidated health repository 108 can obtain associated information from pharmacy benefits component 202, health management component 204, and/or insurance component 206 and thereafter direct the flow of information from these disparate components (e.g., pharmacy benefits component 202, health management component 204, and/or insurance component 206, and the like) to physicians portal 208 for display and utilization by healthcare professionals. Physicians portal 208, upon receipt of the information, can join the disparate information gleaned from pharmacy benefits component 202, health management component 204, and/or insurance component 206 into a coherent form so that the medical professional utilizing physicians portal 208 can effectively treat the individual using, wearing, and/or carrying communicator device 102.

It should be noted that like consolidated health repository 108, pharmacy benefits component 202, health management component 204, insurance component 206, and physicians portal 208 can be any type of engine, machine, instrument of conversion, or mode of production that includes a processor and/or is capable of effective and/or operative communications with network topology and/or cloud 106. Illustrative instruments of conversion, modes of production, engines, mechanisms, devices, and/or machinery that can comprise and/or embody pharmacy benefits component 202, health management component 204, insurance component 206, and physicians portal 208 can include desktop computers, server class computing devices and/or databases, cell phones, smart phones, laptop computers, notebook computers, Tablet PCs, consumer and/or industrial devices and/or appliances and/or processes, hand-held devices, personal digital assistants, multimedia Internet enabled mobile phones, multimedia players, and the like.

It should be further be noted that storage or persistence media 202_{A}, persistence media 204_{A}, and storage devices 206_{A} associated, affiliated, and/or confederated with pharmacy benefits component 202, health management component 204, and insurance component 206, respectively, can include any suitable data necessary for each of pharmacy benefits component 202, health management component 204, and insurance component 206 to facilitate their objectives. For instance, storage or persistence media 202_{A}, persistence media 204_{A}, and storage devices 206_{A} can include information regarding user data, data related to a portion of a transaction, credit information, historic data related to a previous transaction, a portion of data associated with purchasing a good and/or service, a portion of data associated with selling a good and/or service, geographical location, online activity, previous online transactions, activity across disparate networks, activity across a network, credit card verification, membership, duration of membership, communication associated with a network, buddy lists, contacts, questions answered, questions posted, response time for questions, blog data, blog entries, endorsements, items bought, items sold, products on the network, information gleaned from a disparate website, information obtained from the disparate network, ratings from a website, a credit score, geographical location, a donation to charity, or any other information related to software, applications, web conferencing, and/or any suitable data related to transactions, etc.

It is to be appreciated that storage or persistence media 202_{A}, persistence media 204_{A}, and storage devices 206_{A} can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM). Storage or persistence media 202_{A}, persistence media 204_{A}, and storage devices 206_{A} of the subject systems and methods are intended to comprise, without being limited to, these and any other suitable types of memory. In addition, it is to be appreciated that storage or persistence media 202_{A}, persistence media 204_{A}, and storage devices 206_{A} can be a server, a database, a hard drive, and the like.

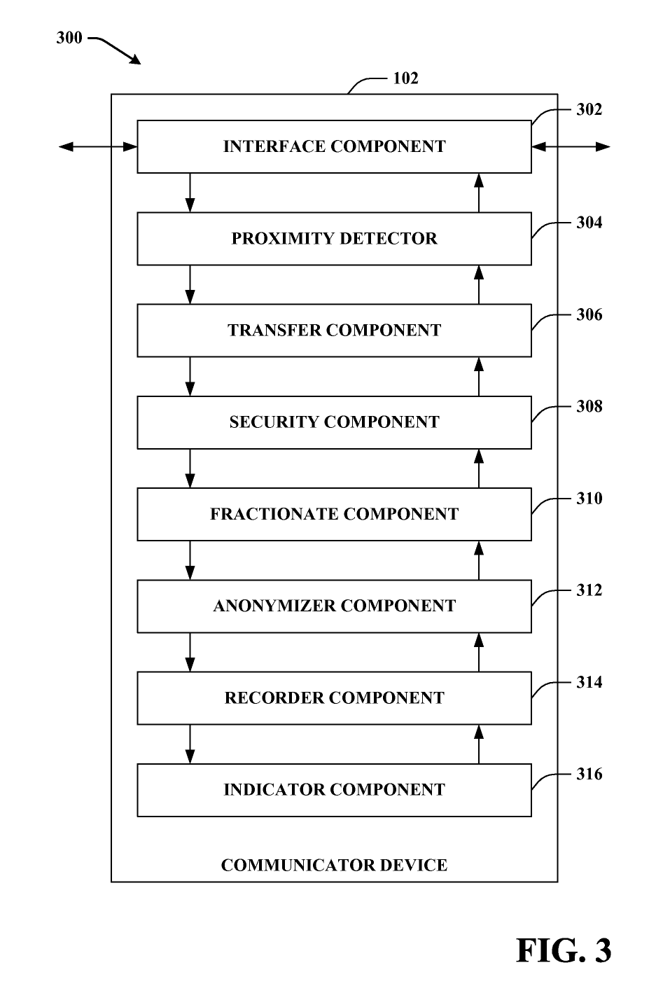

FIG. 3 provides a more detailed depiction 300 of communicator device 102 in accordance with an aspect of the claimed subject matter. As indicated supra, communicator device 102 can be portable and/or can be included with, or incorporated in, textiles, fabrics, clothing, jewelry, or any item that can be worn. Communicator device 102 can include interface component 302 (hereinafter referred to as “interface 102”) that can receive and/or disseminate, communicate, and/or partake in data interchange with a plurality of disparate sources and/or components. For instance, interface 302 can receive and/or transmit data from, or to, a multitude of sources, such as, for example, data associated with health records obtained from consolidated health repository 108. Additionally and/or alternatively, interface 302 can obtain and/or receive data associated with usernames and/or passwords, sets of encryption and/or decryption keys, client applications, services, users, clients, devices, and/or entities involved with a particular transaction, portions of transactions, and thereafter can convey the received or otherwise acquired information to one or more of proximity detector 304, transfer component 306, security component 308, fractionate component 310, anonymizer component 312, recorder component 314, and indicator component 316, for subsequent utilization, processing, and/or analysis. To facilitate its objectives, interface 302 can provide various adapters, connectors, channels, communication pathways, etc. to integrate the various components included in system 300 into virtually any operating system and/or database system and/or with one another. Additionally and/or alternatively, interface 302 can provide various adapters, connectors, channels, communication modalities, and the like, that can provide for interaction with the various components that can comprise system 300, and/or any other component (external and/or internal), data, and the like, associated with system 300.

As illustrated communicator device 102 can include proximity detector 304 that can detect the proximity, or presence, of proximity sensor 104 with the general vicinity. Upon detection of proximity sensor 104, proximity detector 304 can commence data exchange with proximity sensor 104. Such data interchange can be as simple as a mere recognition that communicator device 102 and proximity sensor 104 are in the presence of one another, or alternatively, a more detailed interchange can take place wherein information regarding the location and purpose of proximity sensor 104 can take place. For example, proximity sensor 104 can indicate to proximity detector 304 that communicator device 102 has entered a medical establishment (e.g., hospital, clinic, doctors' offices, etc.). Alternatively proximity sensor 104 can indicate that communicator device 102 is within a social environment (e.g., church, social club, night club, bar, . . . ).

Additionally and/or alternatively communicator device 102 can also include transfer component 306 that based at least in part on where communicator device 102 is currently located (e.g., as indicated by proximity detector 304) can transfer data to and/or from consolidated health repository. For example, where communicator device 102 is currently situated in a social setting (e.g., speed dating setting), transfer component 306 can instigate consolidated health repository to download blood type, ethnographical information, and other such information that can aid the individual using, carrying, or wearing communicator device 102 to identify a suitable match. Alternatively, where communicator device 102 is positioned in a healthcare setting, transfer component 306 can cause consolidated health repository 108 to aggregate (e.g., from pharmacy benefits component 202, health management component 204, and/or insurance component 206) and communicate health records associated with the individual employing, transporting, or wearing communicator device 102 to communicator device 102.

As will be appreciated, access to, or more specifically unauthorized access to, personal health records can be a highly emotive topic. Thus, in order to prevent unauthorized access to health records robust security features need to be implemented and/or utilized. Accordingly, communicator device 102 can include security component 308 that can utilize cryptographic keys to unlock or lock sensitive data or portions thereof. Security component 308 can selectively protect/secure portions of the health record, granting selective access to individuals or organizations of the users choosing. For instance, an individual may wish that a heart specialist only have access to records related specifically to the individual's heart, or that a neurologist only have access to records involving the individual's brain. In order to facilitate these objectives, security component 308 can employ various encryption schemes that can be based at least in part on asymmetric public key systems (PKS) or symmetric key systems (e.g., block ciphers or stream ciphers). Examples of cryptographic asymmetric public key systems that can be employed by the claimed subject matter include techniques such as Diffie-Hellman, Digital Signature Standard (DSS), various elliptic curve modalities, RSA, Cramer-Shoup, Merkle-Hellman ‘knapsack’ algorithms, Paillier cryptosystems, etc. Examples of symmetric key systems that can be employed with equal utility by the claimed subject matter can include techniques such as Twofish, the Advanced Encryption Standard (AES), Blowfish, Serpent, RC4, Triple Data Encryption Standard (TDES), International Data Encryption Algorithm (IDEA), and the like. Moreover it should be noted, solely for the purposes of exposition rather than limitation, that the key lengths that can be utilized for purposes of encryption or decryption can be greater than or less than the 2⁷- or 2⁸-bits currently and typically practicable in this field of endeavor. Moreover, security component 308 can also utilize biometrics (e.g., retinal scans, iris scans, finger prints, perspiration analysis, and the like) to ensure the security and access of personal health records associated with consolidated health repository 108.

Further, communicator device 102 can also include fractionate component 310 that at the behest of the individual utilizing or wearing communicator device 102 can selectively fractionate or mask aspects of the health record transferred from consolidated health repository 108. For example, an individual utilizing communicator device 102 may want to selectively mask all aspects of his or her health records from his or her insurance carrier. Similarly, the individual may wish that their heart specialist only be provided records associated with their heart, and their dermatologist only be provided aspects related to the skin. Accordingly, fractionate component 310 can effectuate and facilitate this aspect of the claimed subject matter.

Anonymizer component 312 can also be included with communicator device 102. In a similar vein to fractionate component 310, anonymizer component 312 can ensure that when information is transferred from consolidated health repository 108 to physicians portal 208, for instance, that identifying or particularly personal information is redacted or selectively removed or omitted from display of transfer from consolidated health repository 108. Moreover, when communicator device 102 is utilized in a social setting (e.g., speed dating) anonymizer component 312 can ensure that only carefully circumscribed aspects of the health records associated with the individual utilizing communicator device 102 are disseminated or made available in what can be a very public setting.

Moreover, communicator device 102 can include recorder component 314 that can record various aspects associated with the person using communicator device 102. Since communicator device 102, in accordance with an aspect of the claimed subject matter, can be a wearable device incorporated in textiles and/or fabrics, its facilities and functionalities can also include aspects related to monitoring biometric aspects associated with the wearer of the device. For example, communicator device 102 through utilization of recorder component 314 can monitor and/or record body temperature, heart rate, sugar levels, hydration levels, electrolyte intake, blood pressure, ultraviolet exposure, alcohol levels, blood oxygenation, and the like. Additionally, recorder component 314 can record ambient aspects (e.g., ambient temperature, humidity, pollen count, light levels, noise levels, . . . ) of an environment within which communicator device 102 is placed.

Indicator component 316 in conjunction with other aspects of the claimed subject matter can provide indication of matches between different parties with similar or sought after attributes in a social setting. For example, if one were searching for a date with specific characteristics (e.g., someone with a certain ethnographic profile and/or specific blood type) indicator component 316 can provide notification to the wearer of communicator device 102 when persons satisfying the characteristics come within the purview of the device. For example, when persons meeting the characteristics set forth are identified, indicator component 316 can cause communicator device 102 to fluoresce, vibrate, emit light of different wavelengths depending the characteristic matched, etc.

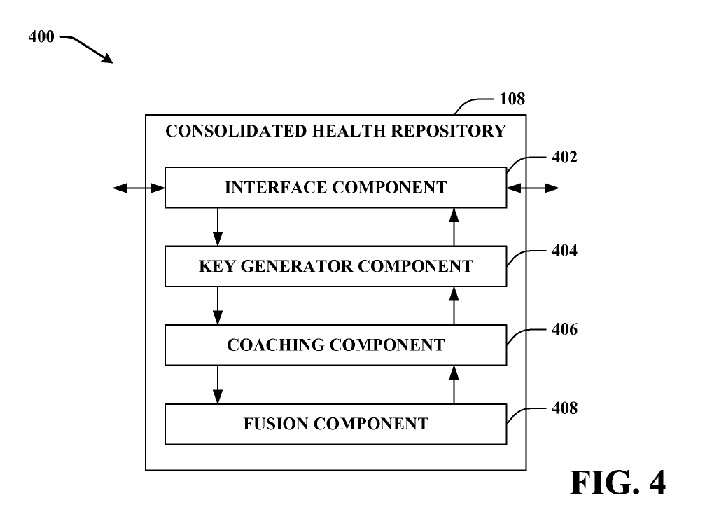

FIG. 4 provides further illustration 400 of consolidated health repository 108 in accordance with an aspect of the claimed subject matter. As depicted, consolidated health repository 108 can include interface component 402 that can have a similar functionality as that outlined earlier with regard to FIG. 3 and interface 302. Accordingly, because much of the configuration and operation of interface 402 is substantially similar to that described with respect to interface 302, a detailed description of such features has been omitted to avoid needless repetition and for the sake of brevity and conciseness.

Because unauthorized access to personal records and especially health records can be an extremely emotive and contentious issue, consolidated health repository 108 needs to ensure that only authorized aspects of a person's health records are divulged (e.g., authorized by the person associated with the health records). Accordingly, because consolidated health repository 108 can have access to, and/or be access by, many disparate and oftentimes insecure devices and components, consolidated health repository 108 can employ key generator component 404. Key generator component 404 can utilize one or more cryptographic devices or schemes to generate encryption and/or decryption keys that can be assigned to accessed and accessing devices and/or components. For example, physicians portal 208, insurance component 206, health management component 204, and pharmacy benefits component 202 can be issued unique but disparate time-limited one-time use keys (e.g., the keys assigned to each of pharmacy benefits component 202, health management component 204, insurance component 206, and physicians portal 208 are different from one another and are valid only for a limited duration whether or not the keys are utilized and the key can only be used once after which the key becomes inoperable) by key generator component 404.

In addition, consolidated health repository 108 can also provide a coaching component 406 that can, in conjunction with communicator device 102, utilize health records persisted on consolidated health repository 108 or obtained from other disparate devices and/or components (e.g., pharmacy benefits component 202, health management component 204, and/or insurance component 206) to devise health regimens that individuals wearing, carrying, or utilizing communicator device 102 can beneficially utilize. For example, if the individual wearing communicator device 102 is morbidly obese, consolidated health repository in concert with communicator device 102 suggest and guide the wearer to more healthy alternatives in order to facilitate or effectuate lifestyle changes.

Consolidated health repository 108 in accordance with an aspect of the claimed subject matter can include fusion component 408 that can be utilized to take advantage of information fission which may be inherent to a process (e.g., receiving and/or deciphering inputs) relating to analyzing inputs through several different sensing modalities. In particular, one or more available inputs may provide a unique window into a physical environment (e.g., an entity inputting instructions) through several different sensing or input modalities. Because complete details of the phenomena to be observed or analyzed may not be contained within a single sensing/input window, there can be information fragmentation which results from this fission process. These information fragments associated with the various sensing devices may include both independent and dependent components.

The independent components may be used to further fill out (or span) an information space; and the dependent components may be employed in combination to improve quality of common information recognizing that all sensor/input data may be subject to error, and/or noise. In this context, data fusion techniques employed by fusion component 408 may include algorithmic processing of sensor/input data to compensate for inherent fragmentation of information because particular phenomena may not be observed directly using a single sensing/input modality. Thus, data fusion provides a suitable framework to facilitate condensing, combining, evaluating, and/or interpreting available sensed or received information in the context of a particular application.

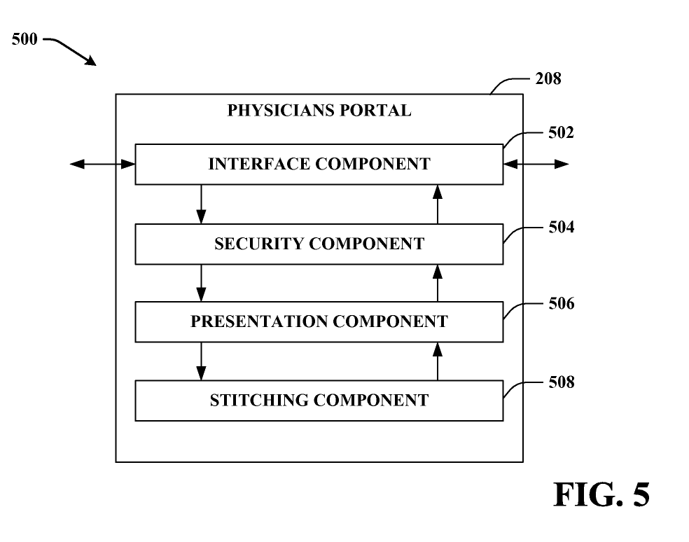

FIG. 5 provides depiction 500 of an illustrative physicians portal 208 in accordance with an aspect of the claimed subject matter. As illustrated physicians portal 208 can include interface component 502 that can have a similar functionality as that described earlier in context with FIG. 3 and interface 302. Accordingly, for the sake of conciseness of description a detailed description of such features have been omitted.

Physicians portal 208 can also include security component 504 which in functionality and scope operates in a similar manner to that exposited in connection with security component 308 as illustrated in FIG. 3. Accordingly, because much of the configuration and operation of security component 504 is substantially similar to that described with respect to security component 308, a detailed description of such features has been omitted to avoid needless repetition and for the sake of brevity and conciseness.

As illustrated, physicians portal 208 can include presentation component 506 that can provide various types of user interface to facilitate interaction between a user and any component coupled to physicians portal 208. Presentation component 506 can provide one or more graphical user interface, command line interface, and the like. For example, a graphical user interface can be rendered that provides the user with a region or means to load, import, read, etc., data, and can include a region to present the results of such. These regions can comprise known text and/or graphic regions comprising dialog boxes, static controls, drop-down menus, list boxes, pop-up menus, edit controls, combo boxes, radio buttons, check boxes, push buttons, and graphic boxes. In addition, utilities to facilitate the presentation such as vertical and/or horizontal scrollbars for navigation and toolbar buttons to determine whether a region will be viewable can be employed. For example, the user can interact with one or more of the components coupled and/or incorporated into physicians portal 208.

Users can also interact with regions to select and provide information via various devices such as a mouse, roller ball, keypad, keyboard, and/or voice activation, for example. Typically, mechanisms such as a push button or the enter key on the keyboard can be employed subsequent to entering the information in order to initiate, for example, a query. However, it is to be appreciated that the claimed subject matter is not so limited. For example, merely highlighting a checkbox can initiate information conveyance. In another example, a command line interface can be employed. For example, the command line interface can prompt (e.g., via text message on a display and/or an audio tone) the user for information via a text message. The user can then provide suitable information, such as alphanumeric input corresponding to an option provided in the interface prompt or an answer (e.g., verbal utterance) to a question posed in the prompt. It is to be appreciated that the command line interface can be employed in connection with a graphical user interface and/or application programming interface (API). In addition, the command line interface can be employed in connection with hardware (e.g., video cards) and/or displays (e.g., black-and-white, and EGA) with limited graphic support, and/or low bandwidth communication channels.

Physicians portal 208 can also include stitching component 508 to combine, or filter information received from a variety of inputs (e.g., text, speech, gaze, environment, audio, images, gestures, noise, temperature, touch, smell, handwriting, pen strokes, analog signals, digital signals, vibration, motion, altitude, location, GPS, wireless, etc.), in raw or parsed (e.g. processed) form. Stitching component 508 through combining and filtering can provide a set of information that can be more informative, or accurate (e.g., with respect to an entity's communicative or informational goals) and information from just one or two modalities, for example. Moreover, and similar to fusion component 408 as described in connection with consolidated health repository 108 above, a data fusion component can also be employed to learn correlations between different data types, and stitching component 508 can employ such correlations in connection with combining, or filtering the input data.

Additionally, stitching component 508 can determine context associated with a particular action or set of input data. As can be appreciated, context can play an important role with respect understanding meaning associated with particular sets of input, or intent of an individual or entity. For example, many words or sets of words can have double meanings (e.g., double entendre), and without proper context of use or intent of the words the corresponding meaning can be unclear thus leading to increased probability of error in connection with interpretation or translation thereof. Stitching component 508 can provide current or historical data in connection with inputs to increase proper interpretation of inputs. For example, time of day may be helpful to understanding an input—in the morning, the word “drink” would likely have a high a probability of being associated with coffee, tea, or juice as compared to being associated with a soft drink or alcoholic beverage during late hours. Context can also assist in interpreting uttered words that sound the same (e.g., steak and, and stake). Knowledge that it is near dinnertime of the user as compared to the user camping would greatly help in recognizing the following spoken words “I need a steak/stake”. Thus, if the stitching component 508 had knowledge that the user was not camping, and that it was near dinnertime, the utterance would be interpreted as “steak”. On the other hand, if the stitching component 508 knew (e.g., via GPS system input) that the user recently arrived at a camping ground within a national park; it might more heavily weight the utterance as “stake”.

In view of the foregoing, it is readily apparent that utilization of the context aspect of stitching component 508 to consider and analyze extrinsic information can substantially facilitate determining meaning of sets of inputs.

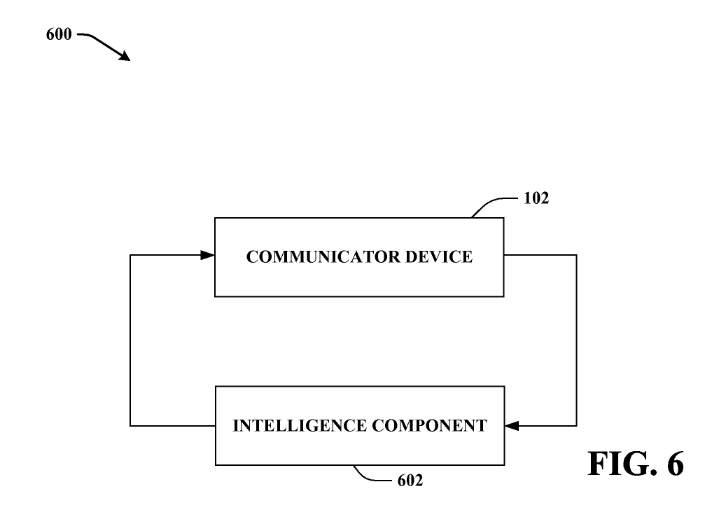

FIG. 6 depicts a system 600 that employs artificial intelligence to facilitate and/or effectuate accurate communication of health data in accordance with an aspect of the subject matter as claimed. Accordingly, as illustrated, system 600 can include an intelligence component 602 that can employ a probabilistic based or statistical based approach, for example, in connection with making determinations or inferences. Inferences can be based in part upon explicit training of classifiers (not shown) before employing system 300, or implicit training based at least in part upon system feedback and/or users previous actions, commands, instructions, and the like during use of the system. Intelligence component 602 can employ any suitable scheme (e.g., neural networks, expert systems, Bayesian belief networks, support vector machines (SVMs), Hidden Markov Models (HMMs), fuzzy logic, data fusion, etc.) in accordance with implementing various automated aspects described herein. Intelligence component 602 can factor historical data, extrinsic data, context, data content, state of the user, and can compute cost of making an incorrect determination or inference versus benefit of making a correct determination or inference. Accordingly, a utility-based analysis can be employed with providing such information to other components or taking automated action. Ranking and confidence measures can also be calculated and employed in connection with such analysis.

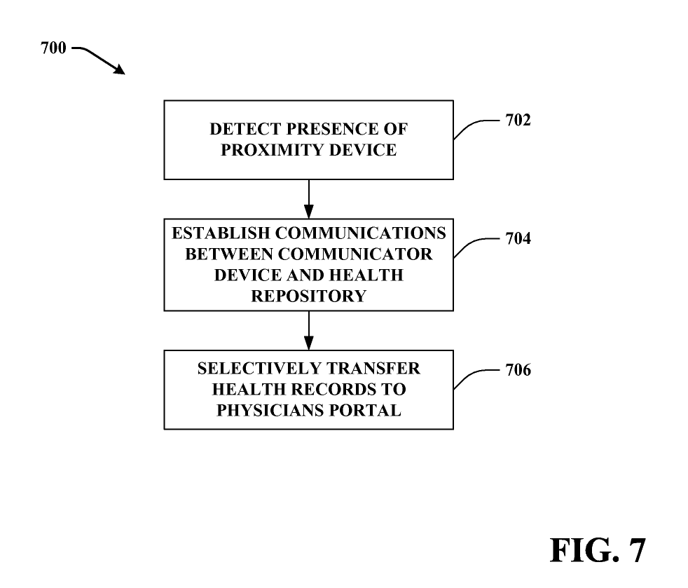

In view of the exemplary systems shown and described supra, methodologies that may be implemented in accordance with the disclosed subject matter will be better appreciated with reference to the flow chart of FIG. 7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 7 provides a method 700 implemented on a machine that facilitates and/or effectuates accurate communication of health data in accordance with an aspect of the claimed subject matter. Method 700 can commence at 702 where a communicator device 102 can detect the presence of a proximity detector 104. Alternatively and/or additionally proximity detector 104 can also sense the presence of communicator device 102 and both communicator device 102 and proximity detector 104 can send acknowledgement of the other's existence in the vicinity, or note can be made on respective persistence means associated with each of communicator device 102 and proximity detector 102 (e.g., flash memory) that contact was made. At 704 communications can be initiated by communicator device 102 with consolidated health repository 108 via proximity detector 104. Initiating communications between communicator device 102 and consolidated health repository can take the form of sending biometric information associated with a user of the communicator device 102 and/or interchanging cryptographic keys and/or username and password couplets, for example. At 706 at the instigation of communicator device 102 carefully circumscribed aspects of the health record associated with the user of communicator device 102 can be transferred, for example, to physician portal 208. It should be noted that the transferred or downloaded circumscribed aspects of the health record can be dependent on the situational awareness of communicator device 102 (e.g., this can be provided by an intelligence component). For example, one set of circumscribed aspects of the health record can be downloaded where the user of communicator device 102 is wheeled incoherent into an hospital emergency room, and a different set of restricted aspects can be communicated when the user of communicator device 102 is in a social setting.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

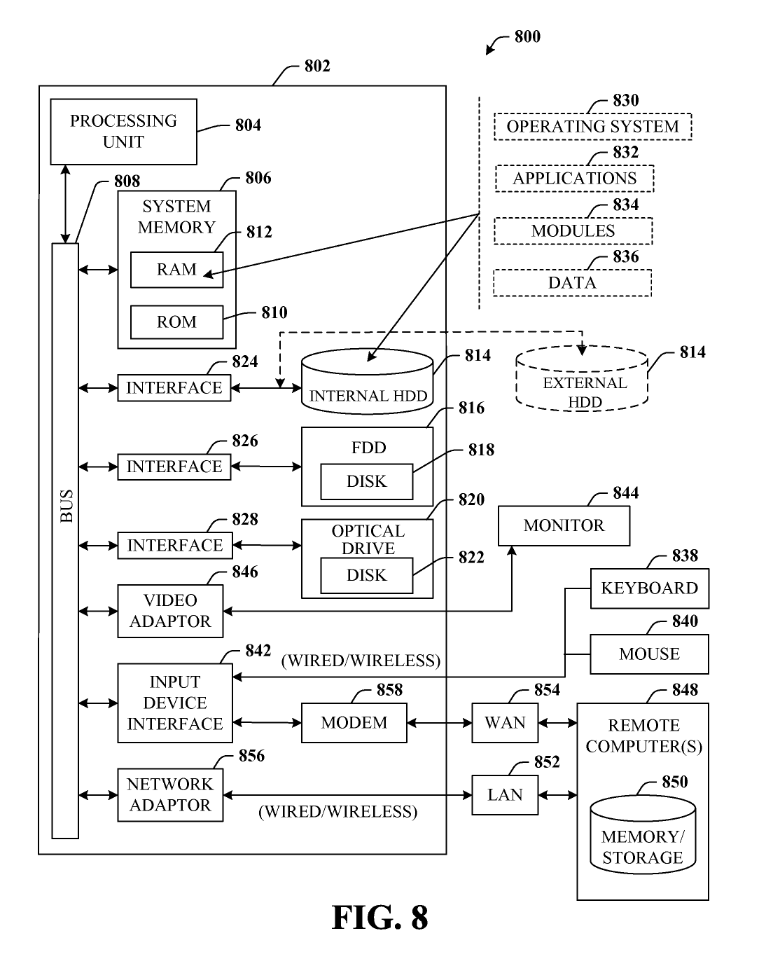

Referring now to FIG. 8, there is illustrated a block diagram of a computer operable to execute the disclosed system. In order to provide additional context for various aspects thereof, FIG. 8 and the following discussion are intended to provide a brief, general description of a suitable computing environment 800 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 8, the exemplary environment 800 for implementing various aspects includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1094 interface technologies. Other external drive connection technologies are within contemplation of the claimed subject matter.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed and claimed subject matter.

A number of program modules can be stored in the drives and RAM 812, including an operating system 830, one or more application programs 832, other program modules 834 and program data 836. All or portions of the operating system, applications, modules, and/or data can also be cached in the RAM 812. It is to be appreciated that the claimed subject matter can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1094 serial port, a game port, a USB port, an IR interface, etc.

A monitor 844 or other type of display device is also connected to the system bus 808 via an interface, such as a video adapter 846. In addition to the monitor 844, a computer typically includes other peripheral output devices (not shown), such as speakers, printers, etc.

The computer 802 may operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adaptor 856 may facilitate wired or wireless communication to the LAN 852, which may also include a wireless access point disposed thereon for communicating with the wireless adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

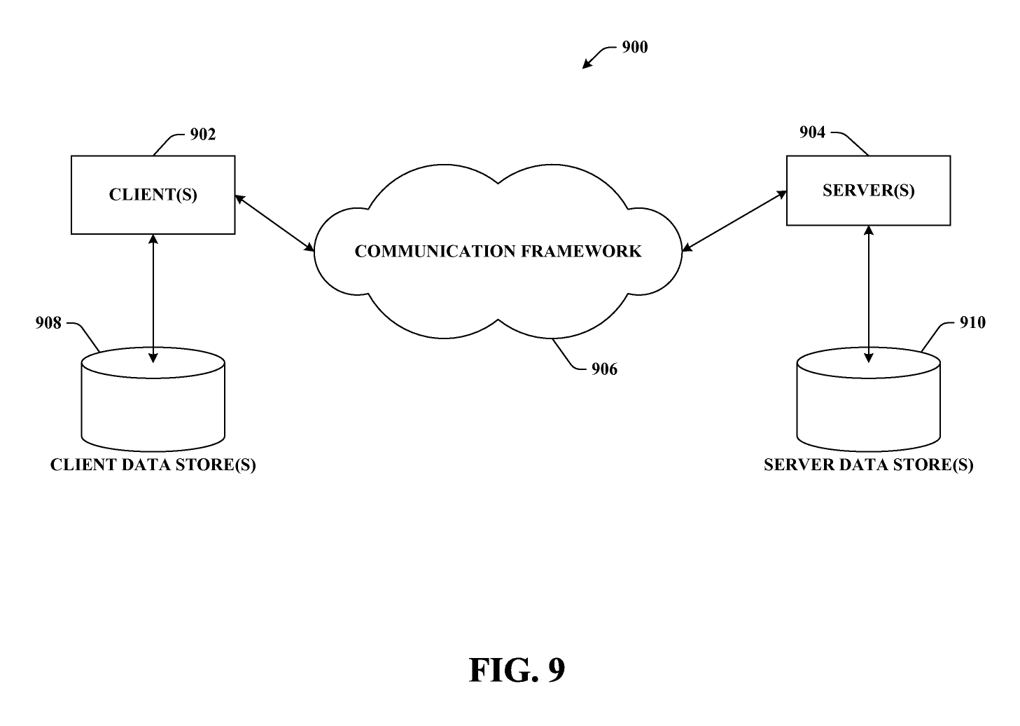

Referring now to FIG. 9, there is illustrated a schematic block diagram of an exemplary computing environment 900 for processing the disclosed architecture in accordance with another aspect. The system 900 includes one or more client(s) 902. The client(s) 902 can be hardware and/or software (e.g., threads, processes, computing devices). The client(s) 902 can house cookie(s) and/or associated contextual information by employing the claimed subject matter, for example.

The system 900 also includes one or more server(s) 904. The server(s) 904 can also be hardware and/or software (e.g., threads, processes, computing devices). The servers 904 can house threads to perform transformations by employing the claimed subject matter, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A machine implemented system that facilitates and effectuates accurate communication of health data, comprising:
a component that detects a proximity sensor and initiates data interchange with a records manager, the component selectively causes a physicians portal to acquire and display a personal health record associated with a user of the component.

2. The system of claim 1, the component acquires an aspect of the personal health record associated with the user of the component and provides indication of a match with a second component that acquires an aspect of a personal health record associated with an individual utilizing the second component.

3. The system of claim 2, the match based at least in part on a shared ethnological characteristic or a shared medical characteristic.

4. The system of claim 1, the component utilizes a cryptographic key to provide the physicians portal access to the personal health record associated with the user of the component.

5. The system of claim 1, the component selectively screens off an aspect of the health record associated with the user of the component from acquisition by the physicians portal.

6. The system of claim 1, the records manager utilizes a cryptographic key dispensed by the component to access a pharmacy component or an insurance component, the records manager utilizes records from each of the pharmacy component or the insurance component associated with the cryptographic key to stitch the records from the pharmacy component or the insurance component together with the personal health record associated with the user of the component.

7. The system of claim 1, the personal health record includes a familial disposition to a disease or an ethnological vulnerability to a particular ailment.

8. The system of claim 1, the personal health record includes an indication of a travel itinerary associated with the user of the component.

9. The system of claim 1, the component included in at least one or more of textiles, fabrics, or jewelry.

10. A machine implemented method that effectuates accurate communication of health data, comprising:
detecting a proximity detector;
initiating communications with a consolidated health repository; and
transferring circumscribed aspects of a health record to a physicians portal.

11. The method of claim 10, the initiating further comprising at least one or more of interchanging cryptographic keys, username and password couplets, or biometric information associated with a user.

12. The method of claim 10, further comprising acquiring an aspect of the health record associated with a first user and providing indication of a match with a second user, the match based on a shared characteristic between the first user and the second user.

13. The method of claim 12, the shared characteristic related to at least one of an ethnographical characteristic or a medical characteristic.

14. The method of claim 10, the circumscribed aspects of the health record selectively made available to an individual based on a situational location.

15. The method of claim 14, the situational location relates to one or more of a hospital location or a social location.

16. The method of claim 10, the proximity detector included in wireless telephonic communication equipment.

17. The method of claim 10, the proximity detector employed to monitor one of activity or inactivity associated with a user of the health record.

18. A system that facilitates communication of health data, comprising:
means for detecting proximity to a means for transmitting;
means for initiating communications with a means for persisting health records; and
means for transferring circumscribed aspects of a health record to means for communicating medical information.

19. The system of claim 18, the means for initiating communication employs one or more of cryptographic keys, username and password couplets, or biometric information associated with a user.

20. The system of claim 18, the means for detecting proximity utilized to monitor at least one of activity or inactivity associated with a users of the means for transmitting.
